(19) United States
(12) Patent Application Publication
(10) Pub. No.: US 2005/0168546 A1
(43) Pub. Date: Aug. 4, 2005

(54) Cartridge for a printer

(75) Inventors: William John Studholme, Lincolnshire (GB); John William Studholme, Lincolnshire (GB); Kevin Vickers, Lincolnshire (GB)

Correspondence Address: PEARNE & GORDON LLP, 1801 EAST 9TH STREET, SUITE 1200, CLEVELAND, OH, 44114-3108, US

(73) Assignee: Dynamic Cassette International Ltd., Lincolnshire (GB)

(21) Appl. No.: 11/024,130

(22) Filed: Dec. 28, 2004

(30) Foreign Application Priority Data
Dec. 29, 2003 (GB) 0330111.6

(51) Int. Cl. B41J 2/175

(52) U.S. Cl. 347/86

(57) ABSTRACT

A cartridge 10 for a printer comprises an ink tank 12 and a detent 36, 38 for holding the cartridge 10 in a printer or on a shoe 26 for mounting in a printer. The detent 36, 38 is provided on a loop 16 which is attached to the ink tank 12 at two spaced apart positions, the resilience of the loop 16 resiliently biasing the detent 36, 38 into position.

The invention relates to a cartridge for a printer.

A known ink cartridge is arranged to fit into a shoe for mounting in a printer. The cartridge has two wide projections, one above the other on one end of the tank to be received in corresponding recesses in the shoe. At the opposite end of the ink tank the cartridge has a lever. The lever is attached at a low level and has an outwards projection about half way along its length. The projection is received in a corresponding recess in the shoe, in use. The lever is integral with the ink tank and is made from resilient plastics material so that the top of the lever can be moved by a user, the remainder of the lever flexing resiliently to accommodate this movement.

When the cartridge is to be mounted in the shoe, the upper of the two wide projections is located in its recess and the cartridge is pivoted into the shoe. As the cartridge enters the shoe, the upper part of the lever is pushed inwards by contact with the wall of the shoe until the projection on the lever rides into its recess. The lower wide projection also enters a recess in the wall of the shoe. The cartridge is thus held in place by engagement of the projections on the lever and ink tank in the respective recesses in the shoe.

The cartridge can then be removed by pushing the end of the lever inwards, towards the ink tank. In this way the projection on the lever is moved out of the recess in the shoe and the cartridge can then be pivoted back out of the shoe.

The lever is an awkward shape which can get caught on things in handling. Also, the lever has to be pushed right against the cartridge to remove the projection from the recess and may not always work easily or reliably.

According to the invention, there is provided a cartridge for a printer, the cartridge comprising an ink tank and a detent for holding the cartridge in a printer or in a shoe or other holder for mounting in a printer, the detent being provided on a member which is attached to the ink tank at two spaced apart positions, the arrangement being such that the detent is resiliently biased into position.

The member may be any suitable shape but preferably the member is an elongate member. In a preferred embodiment each end of the member is attached to the ink tank. This shape is less awkward than the lever with its free end which can become caught on things in handling. The member is preferably in the form of a strip. The member may be integral with the ink tank.

The detent may be provided at any suitable position on the member, but preferably the detent is provided between the positions at which the member is attached to the ink tank. Preferably the detent is spaced from the positions at which the member is attached to the ink tank and may be substantially central between those positions.

The detent may take any suitable form and may comprise a projection or a lip. The member may divert outwardly to form the detent.

The detent may be resiliently biased in any desired way, but in a preferred embodiment, at least part of the member is resiliently deformable so that the detent is resiliently biased into position. Preferably at least parts of the member to either side of the detent are resiliently deformable. The member may comprise two spacers, each spacer being attached to the ink tank and spacing an elongate, intermediate part of the member from the ink tank, the detent being provided on the intermediate part. Preferably the intermediate part is resiliently flexible. Preferably the intermediate part is in the form of a strip. The detent is preferably spaced from the spacers and may be substantially central along the intermediate part. At least one spacer may be rigid in the direction of movement of the detent out of the locking position. Where the member is a strip, the spacers may be the ends of the strip which may be at least at 45° to the surface of the ink tank to which they are attached. At least one end of the strip may be substantially normal to the surface of the ink tank to which it is attached. Preferably the member is attached at upper and lower positions and the attachment to the lower position is preferably at about 45° and the attachment to the upper position is preferably substantially normal to the surface of the ink tank to which it is attached.

A finger press pad may be provided on the member. The pad may be wider than the rest of the member. The pad may have grip formations thereon. The pad is preferably provided between the positions at which the member is attached to the ink tank. Where spacers are provided and an intermediate part, the pad is preferably provided on the intermediate part. Where the member is attached at upper and lower positions, the pad is preferably between the detent and the upper attachment position.

An outwards projection may be provided on the other side of the ink tank from the member for location in a recess in a printer or in a shoe or other cartridge holder for mounting in a printer.

An embodiment of the invention will now be described by way of example and with reference to the accompanying drawings, in which:

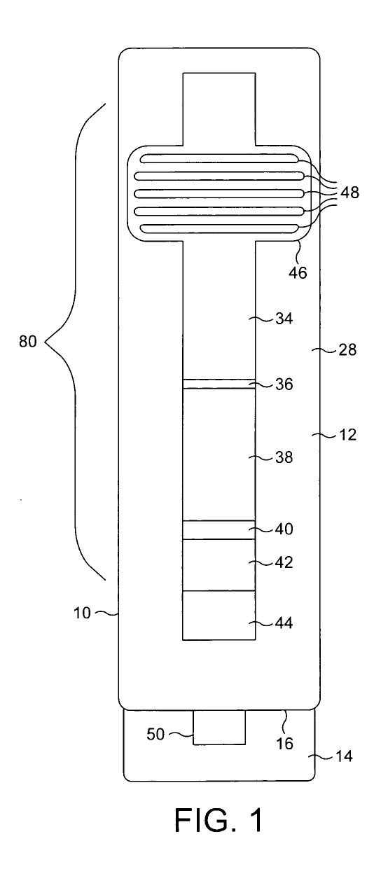

FIG. 1 is an end elevation of a cartridge in the embodiment of the invention;

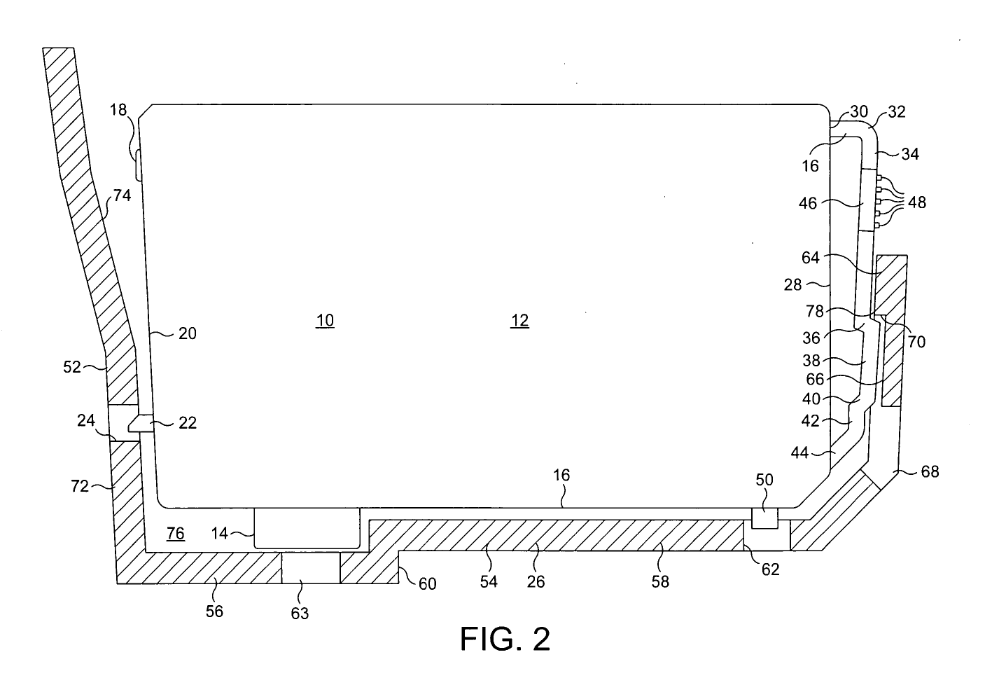

FIG. 2 is a side elevation of the cartridge of FIG. 1 in a shoe, the shoe being shown in cross-section;

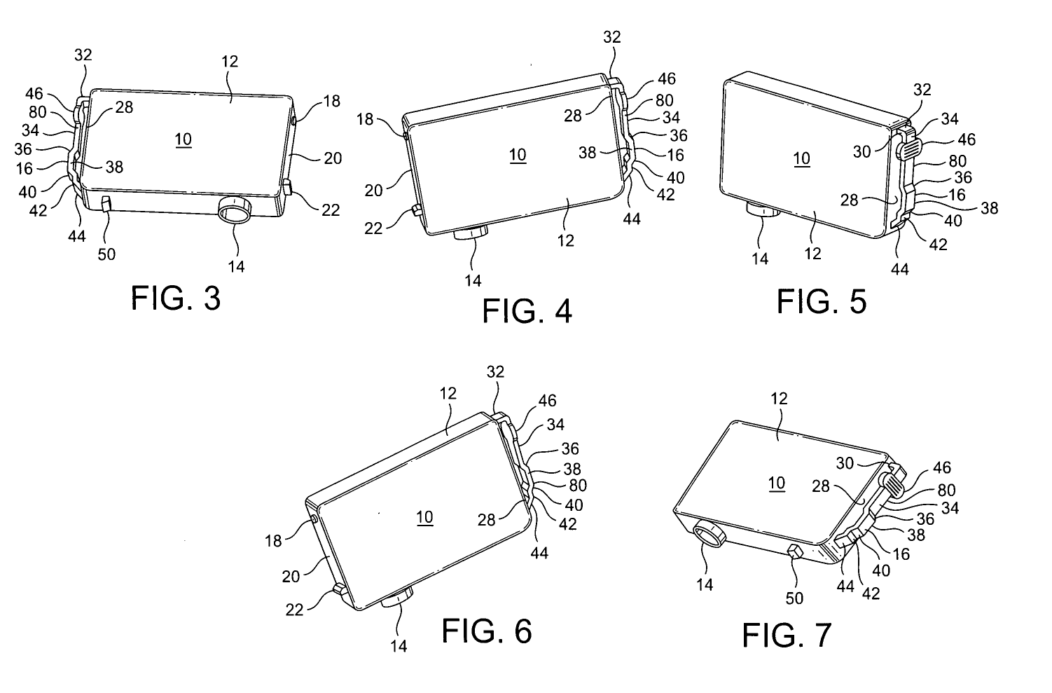

FIGS. 3 to 7 are perspective views of the cartridge of FIG. 1; and

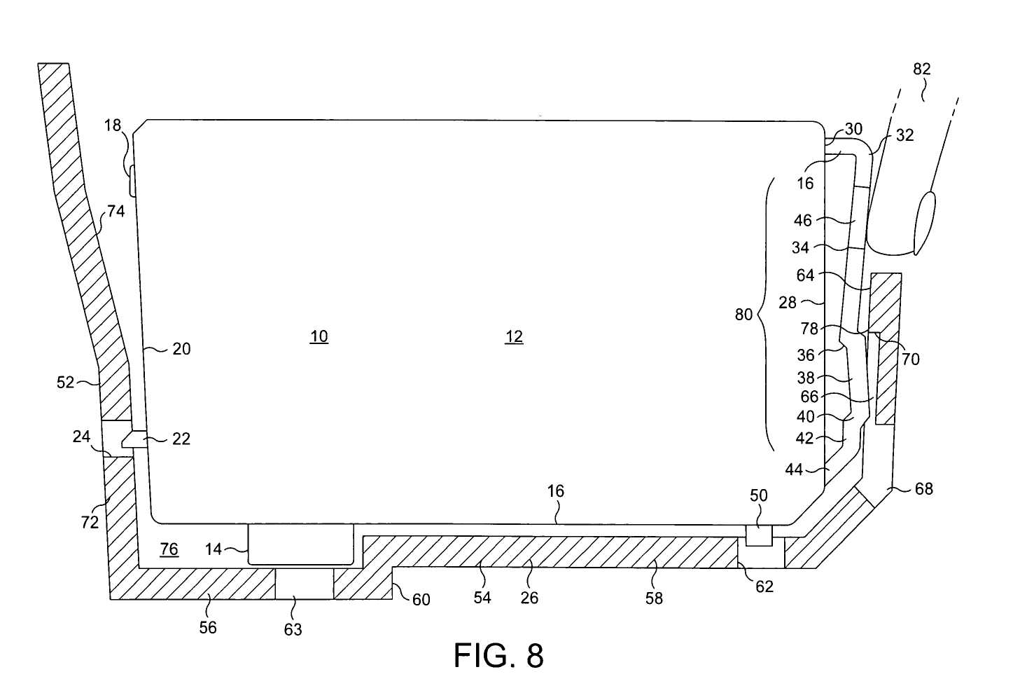

FIG. 8 is the view of FIG. 2 with the loop being pressed by a user's finger.

The cartridge 10 of the embodiment of the invention comprises an ink tank 12 with an 25 outlet tube 14 and a loop 16 (which constitutes the aforesaid “member”).

The ink tank 12 is generally of a slim rectangular shape. The outlet tube 14 depends from the floor 16 of the ink tank 12. An air vent 18 is provided towards the top of one slim end wall 20. An outwards projection 22 is provided on the same end wall 20 below the air vent 18 about a quarter of the way up the end wall 20. As shown in FIG. 2, the projection 22 is arranged to be received in a corresponding recess 24 in the wall 52 of the shoe 26. The outlet tube 14 is closer to the end wall 20 which has the outwards projection 22 and the air vent 18 than the opposite end wall 28.

The end wall 28 carries the loop 16. The loop 16 is in the form of a strip attached at each end to the end wall 28 of the ink tank 12. Thus at its upper end 30, the loop 16 is attached to the wall 28 and the first part 32 of the loop 16 extends outwardly normal to the upright wall 28. The loop 16 then turns through substantially a right angle and the next part 34 of the loop 16 extends downwardly at substantially constant spacing from the flat upright surface of the end wall 28 of the ink tank 12. The loop 16 then diverts outwardly at an acute angle over a short distance. This diverted angled part 36 leads to another downwardly extending part 38. The angled part 36 and second downwardly extending part 38 define the aforesaid “detent”. The loop 16 then diverts inwardly towards the ink tank 12 at an acute angle over a short distance. This second angled part 40 leads to another downwardly extending part 42 which in turn leads to a connecting part 44 which leads back to and is connected to the end wall 28 of the ink tank 12. The connecting part 44 is at about 45° to the wall 28 and extends upwardly therefrom. The angled parts 36, 40 mirror one another about a horizontal symmetry plane halfway between the two. The loop 16 is of constant width except for a widened pad area 46 in the first downwards part 34. The pad 46 is spaced from the first part 32 of the loop 16 and is about one third of the way down the first downwards part 34. The loop 16 is of substantially constant thickness except for the pad 46, which includes five parallel horizontal ridges 48.

The cartridge 10 also includes a downwards projection 50 on the underside 16 of the ink tank 12, at the end of the tank 12 adjacent the end wall 28 which carries the loop 16.

The shoe 26 is generally in the form of an open topped box. The shoe 26 has a recess 24 in its rear wall 52 to receive the wide projection 22. The floor 54 of the shoe 26 is stepped, the lower section 56 of the floor 54 receiving the outlet tube 14 of the cartridge 10, and the upper section 58, beyond the step 60, defining an aperture 62 to receive the downwards projection 50. The lower section 56 defines an aperture 63 which is beneath the outlet tube 14 when the cartridge 10 is in the shoe 26. The front wall 64 of the shoe 26 is not as tall as the rear wall 52. When the cartridge 10 is in the shoe 26, the rear wall 52 is taller than the cartridge 10, but the front wall 64 is shorter and terminates below the level of the pad 46 so that the pad 46 is accessible to a user. The front wall 64 defines a recess 66 to receive the second downwardly part 38 of the loop 16. The recess 66 intersects a through aperture 68 at its lower edge, its upper edge being defined by a right angle step 70. The rear wall 52 has a lower, substantially vertical section 72 and, above the level of the recess 24 for the wide projection 22 it diverts outwardly at a small acute angle of about 10° in an upper section 74.

In use, the cartridge 10 is offered up to the shoe 26 so that the rear end 20 of the ink tank 12 lies against the upper section 74 of the shoe 26. The outlet tube 14 enters the recess 76 above the lower section 56 of the floor 54 of the shoe 26. The wide projection 22 enters the aperture 24 in the rear wall 52 of the shoe 26. The second downwardly extending part 38 of the loop 16 engages the front wall 64 of the shoe 26 at the edge 78 of the step 70. As the cartridge 10 is pushed down, the intermediate part 80 of the loop 16, which consists of the first, second and third downwardly extending parts 34, 38, 42 and the two angled parts 36, 40, flexes inwardly. The second downwardly extending part 38 slides over the edge 78 until the edge 78 reaches the upper angled part 36 at which point the intermediate part 80 flexes outwardly so that the second downwardly extending part 38 is in the recess 66 in the shoe 26. The cartridge 10 is thus held in the shoe 26, as shown in FIG. 2.

To remove the cartridge 10 from the shoe 26, the user presses the pad 46 with a finger 82. This flexes the intermediate part 80 of the loop 16 so that the cartridge 10 can pivot out of the shoe 26 with the upper angled part 36 of the loop clearing the edge 70 on the shoe 26.

The loop 16 is seen to be a neat, simple and effective mechanism for holding the cartridge 10 in place in the shoe.

1. A cartridge for a printer, the cartridge comprising an ink tank and a detent for holding the cartridge in a printer or in a shoe or other holder for mounting in a printer, the detent being provided on a member which is attached to the ink tank at two spaced apart positions, the arrangement being such that the detent is resiliently biased into position.

2. A cartridge as claimed in claim 1, wherein the member is an elongate member.

3. A cartridge as claimed in claim 2, wherein each end of the member is attached to the ink tank.

4. A cartridge as claimed in claim 1, wherein the member is in the form of a strip.

5. A cartridge as claimed in claim 1, wherein the member is integral with the ink tank.

6. A cartridge as claimed in claim 1, wherein the detent is provided between the positions at which the member is attached to the ink tank.

7. A cartridge as claimed in claim 1, wherein the detent is spaced from the positions at which the member is attached to the ink tank.

8. A cartridge as claimed in claim 1, wherein the detent is substantially central between the positions at which the member is attached to the ink tank.

9. A cartridge as claimed in claim 1, wherein the detent comprises a projection or a lip.

10. A cartridge as claimed in claim 1, wherein the member diverts outwardly to form the detent.

11. A cartridge as claimed in claim 1, wherein at least part of the member is resiliently deformable so that the detent is resiliently biased into position.

12. A cartridge as claimed in claim 1, wherein at least parts of the member to either side of the detent are resiliently deformable.

13. A cartridge as claimed in claim 1, wherein the member comprises two spacers, each spacer being attached to the ink tank and spacing an elongate, intermediate part of the member from the ink tank, the detent being provided on the intermediate part.

14. A cartridge as claimed in claim 13, wherein the intermediate part is resiliently flexible.

15. A cartridge as claimed in claim 13, wherein the intermediate part is in the form of a strip.

16. A cartridge as claimed in claim 15, wherein the detent is spaced from the spacers.

17. A cartridge as claimed in claim 13, wherein the detent is substantially central along the intermediate part.

18. A cartridge as claimed in claim 13, wherein at least one spacer is rigid in the direction of movement of the detent out of the locking position.

19. A cartridge as claimed in claim 13, wherein where the member is a strip, the spacers are the ends of the strip and are at least at 45° to the surface of the ink tank to which they are attached.

20. A cartridge as claimed in claim 19, wherein at least one end of the strip is substantially normal to the surface of the ink tank to which it is attached.

21. A cartridge as claimed in claim 1, wherein the member is attached at upper and lower positions and the attachment to the lower position is at about 45° and the attachment to the upper position is substantially normal to the surface of the ink tank to which it is attached.

22. A cartridge as claimed in claim 1, wherein a finger press pad is provided on the member.

23. A cartridge as claimed in claim 22, wherein the pad is wider than the rest of the member.

24. A cartridge as claimed in claim 22, wherein the pad has grip formations thereon.

25. A cartridge as claimed in claim 23, wherein the pad is provided between the positions at which the member is attached to the ink tank.

26. A cartridge as claimed in claim 22, wherein where the member is attached at upper and lower positions, the pad is between the detent and the upper attachment position.

27. A cartridge as claimed in claim 1, wherein an outwards projection is provided on the other side of the ink tank from the member for location in a recess in a printer or in a shoe or other cartridge holder for mounting in a printer.
